(19) United States
(12) Patent Application Publication
(10) Pub. No.: US 2017/0195384 A1
(43) Pub. Date: Jul. 6, 2017

(54) Video Playing Method and Electronic Device

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Xu HAN, Tianjin (CN)

(73) Assignees: LE HOLDINGS (BEIJING) CO., LTD., Beijing (CN); LE SHI ZHI XIN ELECTRONIC TECHNOLOGY (TIANJIN) LIM ITED, Tianjin (CN)

(21) Appl. No.: 15/242,138

(22) Filed: Aug. 19, 2016

Related U.S. Application Data
(63) Continuation of application No. PCT/CN2016/089236, filed on Jul. 7, 2016.

(30) Foreign Application Priority Data
Dec. 30, 2015 (CN) 201511015418.0

(51) Int. Cl. H04L 29/06; H04L 29/08

(52) U.S. Cl. CPC H04L 65/4084; H04L 67/42; H04L 67/02

(57) ABSTRACT

The present disclosure discloses a video playing method and an electronic equipment, wherein the method includes: sending a request for downloading a video file to a server; reading metadata header information of the video file, and analyzing the metadata header information to acquire the start offset and the data block size of a first segment of video data and a first segment of audio data; initiating a primary thread and a secondary thread, wherein the primary and secondary thread send a request for downloading the first segment of video data and a request for downloading the first segment of audio data to the server respectively; receiving the returned first segment of video data and the first segment of audio data and playing them synchronously; downloading and playing the next segment of video data and audio data in turn.

### CROSS-REFERENCE TO RELATED APPLICATION

This application is a continuation of International Application No. PCT/CN2016/089236, with an international filing date of Jul. 7, 2016, which claims priority to Chinese Patent Application No. 201511015418.0, filed with State Intellectual Property Office on Dec. 30, 2015, titled “VIDEO PLAYING METHOD, VIDEO PLAYER AND ELECTRONIC DEVICE”, all the contents of which are incorporated herein by reference.

### TECHNICAL FIELD

The present disclosure relates to the technical field of video playing technologies, and in particular, to a video playing method and an electronic equipment.

### BACKGROUND

With the development of science and technologies, information transmission gets faster and faster. As multimedia technologies develop and update continuously, video has become an important way for information transmission, and more and more users select to acquire various information by watching videos.

Usually, we watch a network video via HyperText Transfer Protocol (HTTP). The standard format of such a video file is shown in FIG. 1, that is, the audio data and the video data in the original data moov box of a video file are stored in a segmented data format, such that it is possible to guarantee a smooth play of a video file.

During the implementation of the present disclosure, the inventors find out that problems in related art at least include: in a practical playing process, some play problems caused by a non-standardness of the video file itself may occur. As shown in FIG. 2, in the video format file, the video data and the audio data are stored in a totally independent manner in the original data moov box of the video file; and during the real-time transmission of the video file, a server can only first transmit the video data or the audio data separately, and the player end can only first read the video data or the audio data. Thus, when a user watches a video, a phenomenon that there only provides an image without sound or there only provides a sound without image may occur.

### SUMMARY

Therefore, it is an object of the embodiments of the present disclosure to put forward a video playing method and an electronic equpiment, thereby solving the problem of non-synchronization between the sound and the picture caused by a non-standardness of a video file itself during playing.

In order to solve the above technical problem, first of all, according to a first aspect, one embodiment of the disclosure provides a video playing method, including:

S1: sending a request for downloading a video file to a server;

S2: reading metadata header information of the video file, and analyzing the metadata header information to acquire the start offset and the data block size of a first segment of video data and the start offset and the data block size of a first segment of audio data;

S3: initiating a primary thread and a secondary thread, wherein the primary thread and the secondary thread send a request for downloading the first segment of video data and a request for downloading the first segment of audio data to the server respectively;

S4: receiving the first segment of video data and the first segment of audio data sent by the server according to the request for downloading the first segment of video data and the request for downloading the first segment of audio data, so as to play the first segment of video data and the first segment of audio data synchronously; and

S5: repeating the steps S2-S4, reading the metadata header information and sending a request for downloading the next segment of video data and audio data, and downloading and playing the next segment of video data and audio data successively, until an instruction for stop downloading the video file is received or the download of the video file is completed.

According to a second aspect, one embodiment of the disclosure further provides a non-transitory computer readable storage medium for storing computer executable instructions, wherein the computer executable instructions are configured to carry out any one of the above video playing methods according to the disclosure.

According to a third aspect, one embodiment of the disclosure further provides an electronic equipment that includes: at least one processor and a memory; wherein instructions executable by the at least one processor are stored in the memory, and the instructions are configued to carry out any one of the above video playing methods according to the disclosure.

In the video playing method and the electronic equipment provided by the embodiments of the disclosure, by downloading the video data and the audio data in segments and running double threads, the video data and the audio data may be played synchronously, and the next segment of video data and audio data may be downloaded and played automatically; thus, the problem of a non-synchronization between the sound and the picture caused by the non-standardness of the format of a video file during playing may be avoided, thereby a user experience may be improved.

### BRIEF DESCRIPTION OF THE DRAWINGS

One or more embodiments are illustrated by way of example, and not by limitation, in the figures of the corresponding accompanying drawings, wherein elements having the same reference numeral designations represent like elements throughout. The drawings are not to scale, unless otherwise disclosed.

FIG. 1 shows a standard storage mode of a video file format in the prior art;

FIG. 2 shows a non-standard storage mode of a video file format in the prior art;

FIG. 3 shows a schematic flow chart of a video playing method according to a certain embodiment of the disclosure;

FIG. 4 shows a schematic flow chart of a video playing method according to a certain embodiment of the disclosure;

FIG. 5 shows a structural representation of a video player according to a certain embodiment of the disclosure;

FIG. 6 shows a structural representation of an electronic device according to a certain embodiment of the disclosure; and

FIG. 7 shows a structural representation of an electronic equipment according to a certain embodiment of the disclosure.

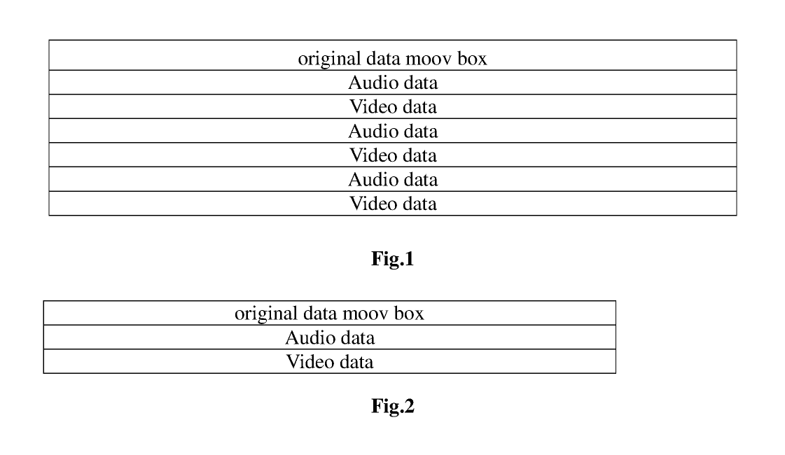

### DETAILED DESCRIPTION

The technical solutions of the disclosure will be further illustrated below in conjunction with the drawings and specific implementation modes. It may be understood that, the specific embodiments described here are only used for explaining the disclosure, rather than limiting the scope thereof. Additionally, it should be noted that, in order to facilitate description, only the parts related to the disclosure, rather than the whole structure, are shown in the drawings.

Before discussing the exemplary embodiments in more detail, it should be noted that some exemplary embodiments are described as processes or methods illustrated by a flow chart. Although a plurality of steps are described as sequential processes in the flow chart, many steps therein may be implemented parallelly, concurrently or simultaneously. In addition, the step sequence may be rearranged. When the steps are completed, the process may be terminated; however, it may further include additional steps that are not included in the drawings. The process may correspond to a method, a method, a function, a procedure, a subroutine and a subprogram, etc.

### Embodiment 1

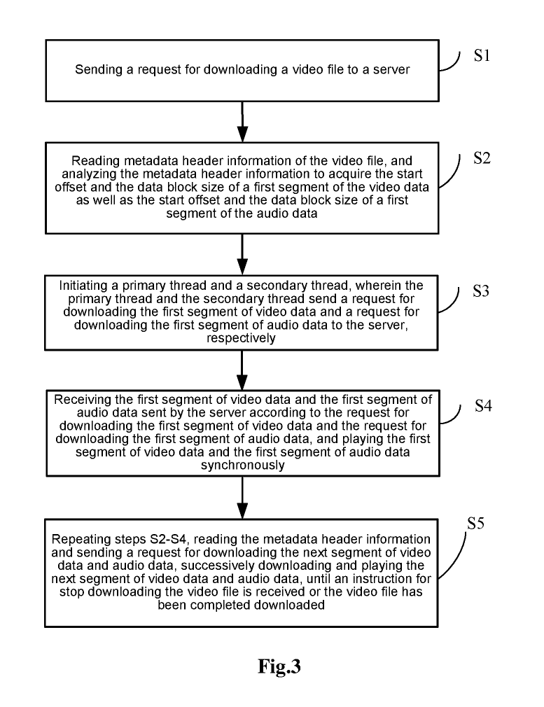

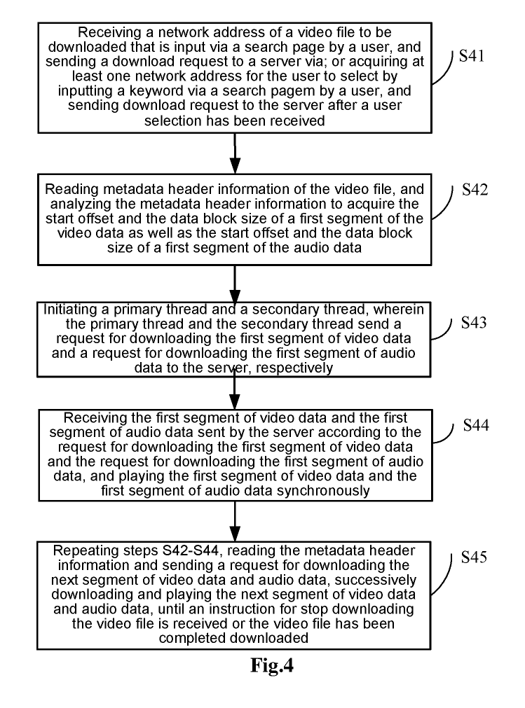

FIG. 3 shows a schematic flow chart of a video playing method according to Embodiment 1 of the disclosure. This method may be executed by a video player of an electronic device, wherein the video player may be implemented by a software and/or hardware, and it generally may be integrated in an electronic device.

The electronic device may be any electronic apparatus, for example, a mobile phone, a tablet computer, an IPAD or a notebook computer, etc.

Referring to FIG. 3, the method of this embodiment includes the steps of:

In step S1: a request for downloading a video file is sent to a server.

Specifically, when a video file needs to be downloaded, a user may click on a related network address to send a download request to the server. The video file includes, but is not limited to, an MP4 file.

Preferably, the user may send a download request to the server via a network address of the video file to be downloaded that is input via a search page; or, the user may acquire at least one network address for the user to select by inputting a keyword via a search page, and after the user selects and clicks on an network address therein, a download request is sent to the server.

Network resources, for example, video files, documents and images, etc., are stored on the server.

In step S2: metadata header information of the video file is read, and the metadata header information is analyzed, so as to acquire the start offset and the data block size of a first segment of the video data as well as the start offset and the data block size of a first segment of the audio data.

Each video file includes metadata header information, while the metadata header information includes a moov box field, the moov box field includes an audio stco field and a video stco field, and the start offset and the data block size of the first segment of audio data may be acquired by analyzing the audio stco field; and the start offset and the data block size of the first segment of video data may be acquired by analyzing the video stco field.

In step S3: a primary thread and a secondary thread is initiated, wherein the primary thread and the secondary thread send a request for downloading the first segment of video data and a request for downloading the first segment of audio data to the server, respectively;

In order to speed up the download, in the embodiment of the disclosure, two threads, i.e., a primary thread and a secondary thread, are initiated, and the primary thread and the secondary thread simultaneously send a request for downloading a first segment of video data and a request for downloading a first segment of audio data to the server, respectively.

Further, the request for downloading the first segment of video data sent by the primary thread to the server includes a start offset and a data block size of the first segment of video data.

The request for downloading the first segment of audio data sent by the secondary thread to the server includes a start offset and a data block size of the first segment of audio data.

In step S4: the first segment of video data and the first segment of audio data sent by the server according to the request for downloading the first segment of video data and the request for downloading the first segment of audio data are received, such that the first segment of video data and the first segment of audio data are played synchronously;

Specifically, after receiving the requests for downloading the first segment of video data and the first segment of audio data, the server sends the first segment of video data and the first segment of audio data to the primary thread and the secondary thread respectively, and the primary thread and the secondary thread deliver the first segment of video data and the first segment of audio data to a video player respectively for playing the first segment of video data and the first segment of audio data synchronously.

In step S5: the steps S2-S4 are repeated, such that the next segment of video data and audio data are downloaded and played successively, until an instruction for stop downloading the video file is received or the video file has been completed downloaded.

Specifically, when the first segment of video data and the first segment of audio data are delivered to the video player for playing, the current primary thread and secondary thread will be freed. In the method of this embodiment, steps S2-S4 are repeated, and it first reads metadata header information of the video file to acquire the start offset and the data block size of a second segment of video data as well as the start offset and the data block size of a second segment of audio data; next, a request for downloading the second segment of video data and a request for downloading the second segment of audio data are sent to server respectively; afterwards, the second segment of video data and the second segment of audio data sent by the server according to the request for downloading the second segment of video data and the request for downloading the second segment of audio data are received for being played synchronously.

Preferably, in order to realize a smooth download and play of the video file, when the second segment of video data and the second segment of audio data are being played, the steps S2-S4 are repeated to implement the download and play of the third segment of video data, and so on, until an instruction for stop downloading the video file is received or the video file has been completed downloaded.

In the technical solution of this embodiment of the disclosure, a request for downloading a video file is sent to a server; the metadata header information of the video file is read, and the metadata header information is analyzed to acquire the start offset and the data block size of a first segment of video data and the start offset and the data block size of a first segment of audio data; a primary thread and a secondary thread are initiated, wherein the primary thread and the secondary thread send a request for downloading the first segment of video data and a request for downloading the first segment of audio data to the server respectively; the first segment of video data and the first segment of audio data returned by the server according to the request for downloading the first segment of video data and the request for downloading the first segment of audio data are received for being played synchronously; the next segment of video data and audio data are downloaded and played in turn until an instruction for stop downloading the video file is received or the download of the video file is completed. By downloading the video data and the audio data in segments and running double threads, the video data and the audio data may be played synchronously, and the next segment of video data and audio data may be downloaded and played automatically; thus, the problem of a non-synchronization between the sound and the picture caused by the non-standardness of the format of a video file during playing may be avoided, thereby a user experience may be improved.

### Embodiment 2

FIG. 4 shows a schematic flow chart of a video playing method according to Embodiment 2 of the disclosure, wherein the video player may be implemented by a software and/or hardware, and it generally may be integrated in an electronic device.

The electronic device may be any electronic apparatus, for example, a mobile phone, a tablet computer, an IPAD or a notebook computer, etc.

Referring to FIG. 4, the method of this embodiment includes the steps of:

In step S41: a network address of a video file to be downloaded that is input via a search page by a user is received, and a download request is sent to a server; or at least one network address for the user to select by inputting a keyword via a search pagem by a user is acquired, and a download request is sent to the server after a user selection has been received.

Specifically, the user may send a download request to the server via a network address of the video file to be downloaded that is input via a search page; or, the user may acquire at least one network address for the user to select by inputting a keyword via a search page, and after the user selects and clicks on an network address therein, a download request is sent to the server. The video file includes, but is not limited to, an MP4 file.

In step S42: metadata header information of the video file is read, and the metadata header information is analyzed, so as to acquire the start offset and the data block size of a first segment of the video data as well as the start offset and the data block size of a first segment of the audio data.

Each video file includes metadata header information, while the metadata header information includes a moov box field, the moov box field includes an audio stco field and a video stco field, and the start offset and the data block size of the first segment of audio data may be acquired by analyzing the audio stco field; and the start offset and the data block size of the first segment of video data may be acquired by analyzing the video stco field.

In step S43: a primary thread and a secondary thread is initiated, wherein the primary thread and the secondary thread send a request for downloading the first segment of video data and a request for downloading the first segment of audio data to the server, respectively;

In order to speed up the download, in the embodiment of the disclosure, two threads, i.e., a primary thread and a secondary thread, are initiated, and the primary thread and the secondary thread simultaneously send a request for downloading a first segment of video data and a request for downloading a first segment of audio data to the server, respectively.

Further, the request for downloading the first segment of video data sent by the primary thread to the server includes a start offset and a data block size of the first segment of video data.

The request for downloading the first segment of audio data sent by the secondary thread to the server includes a start offset and a data block size of the first segment of audio data.

In step S44: the first segment of video data and the first segment of audio data sent by the server according to the request for downloading the first segment of video data and the request for downloading the first segment of audio data are received, such that the first segment of video data and the first segment of audio data are played synchronously;

Specifically, after receiving the requests for downloading the first segment of video data and the first segment of audio data, the server sends the first segment of video data and the first segment of audio data to the primary thread and the secondary thread respectively, and the primary thread and the secondary thread deliver the first segment of video data and the first segment of audio data to a video player respectively for playing the first segment of video data and the first segment of audio data synchronously.

In step S45: the steps S42-S44 are repeated, such that the next segment of video data and audio data are downloaded and played successively, until an instruction for stop downloading the video file is received or the video file has been completed downloaded.

Specifically, when the first segment of video data and the first segment of audio data are delivered to the video player for playing, the current primary thread and secondary thread will be freed. In the method of this embodiment, steps S42-S44 are repeated, and it first reads metadata header information of the video file to acquire the start offset and the data block size of a second segment of video data as well as the start offset and the data block size of a second segment of audio data; next, a request for downloading the second segment of video data and a request for downloading the second segment of audio data are sent to server respectively; afterwards, the second segment of video data and the second segment of audio data sent by the server according to the request for downloading the second segment of video data and the request for downloading the second segment of audio data are received for being played synchronously.

Preferably, in order to realize a smooth download and play of the video file, when the second segment of video data and the second segment of audio data are being played, the steps S42-S44 are repeated to implement the download and play of the third segment of video data, and so on, until an instruction for stop downloading the video file is received or the video file has been completed downloaded.

In the technical solution of this embodiment of the disclosure, a user sends a request for downloading a video file a server; the metadata header information of the video file is read, and the metadata header information is analyzed to acquire the start offset and the data block size of a first segment of video data and the start offset and the data block size of a first segment of audio data; a primary thread and a secondary thread are initiated, wherein the primary thread and the secondary thread send a request for downloading the first segment of video data and a request for downloading the first segment of audio data to the server respectively; the first segment of video data and the first segment of audio data returned by the server according to the request for downloading the first segment of video data and the request for downloading the first segment of audio data are received for being played synchronously; the next segment of video data and audio data are downloaded and played in turn until an instruction for stop downloading the video file is received or the download of the video file is completed. By downloading the video data and the audio data in segments and running double threads, the video data and the audio data may be played synchronously, and the next segment of video data and audio data may be downloaded and played automatically; thus, the problem of a non-synchronization between the sound and the picture caused by the non-standardness of the format of a video file during playing may be avoided, thereby a user experience may be improved.

### Embodiment 3

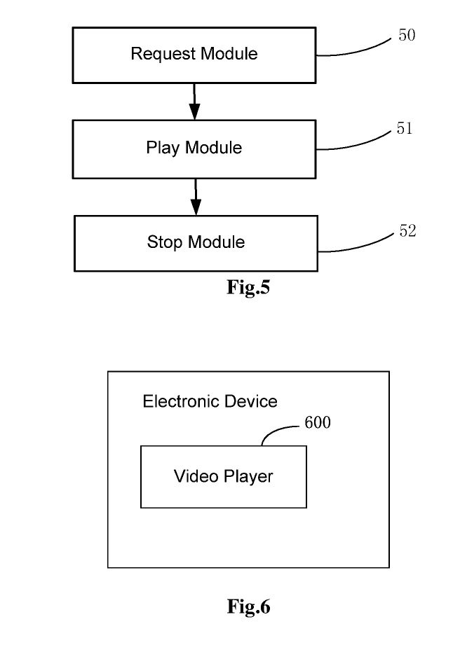

FIG. 5 shows a structural representation of a video player according to Embodiment 3 of the disclosure.

The video player of this embodiment specifically includes: a request module 50 and a play module 51.

Wherein, the request module 50 is configured for sending a request for downloading a video file to a server. Preferably, the user may send a download request to the server via a network address of the video file to be downloaded that is input via a search page; or, the user may acquire at least one network address for the user to select by inputting a keyword via a search page, and after the user selects and clicks on an network address therein, a download request is sent to the server.

The video file includes, but is not limited to, an MP4 file.

Network resources, for example, video files, documents and images, etc., are stored on the server.

The play module 51 is configured for: reading metadata header information of the video file, and analyzing the metadata header information to acquire the start offset and the data block size of a first segment of video data and the start offset and the data block size of a first segment of audio data; initiating a primary thread and a secondary thread, wherein the primary thread and the secondary thread send a request for downloading the first segment of video data and a request for downloading the first segment of audio data to the server respectively; receiving the first segment of video data and the first segment of audio data sent by the server according to the request for downloading the first segment of video data and the request for downloading the first segment of audio data, and playing the first segment of video data and the first segment of audio data synchronously; repeating reading the metadata header information and sending a request for downloading the next segment of video data and audio data, and downloading and playing the next segment of video data and audio data successively, until an instruction for stop downloading the video file is received or the download of the video file is completed.

Specifically, when the first segment of video data and the first segment of audio data are delivered to the video player for playing, the current primary thread and secondary thread will be freed. The video player of this embodiment first reads metadata header information of the video file to acquire the start offset and the data block size of a second segment of video data as well as the start offset and the data block size of a second segment of audio data; next, it sends a request for downloading the second segment of video data and a request for downloading the second segment of audio data to server respectively; further, the second segment of video data and the second segment of audio data sent by the server according to the request for downloading the second segment of video data and the request for downloading the second segment of audio data are received for being played synchronously.

Preferably, in order to realize a smooth download and play of the video file, when the second segment of video data and the second segment of audio data are being played, the above steps are repeated again to implement the download and play of the third segment of video data, and so on, until an instruction for stop downloading the video file is received or the download of the video file is completed.

Preferably, the video player based on the above solutions further includes:

a judge module 52, configured for stop playing the video file if an instruction for stop downloading the video file is received or a download of the audio data and the video data is completed.

For the video player according to the technical solution of this embodiment, the request module 50 is utilized for sending a request to a server for downloading a video file, and the play module 51 is utilized for: reading metadata header information of the video file, and analyzing the metadata header information to acquire the start offset and the data block size of a first segment of video data as well as the start offset and the data block size of a first segment of audio data; initiating a primary thread and a secondary thread, wherein the primary thread and the secondary thread send a request for downloading the first segment of video data and a request for downloading the first segment of audio data to the server respectively; receiving the first segment of video data and the first segment of audio data sent by the server according to the request for downloading the first segment of video data and the request for downloading the first segment of audio data, and playing the first segment of video data and the first segment of audio data synchronously; repeating reading the metadata header information and sending a request for downloading the next segment of video data and audio data, and downloading and playing the next segment of video data and audio data successively until an instruction for stop downloading the video file is received or the download of the video file is completed. By downloading the video data and the audio data in segments and running double threads, the video data and the audio data may be played synchronously, and the next segment of video data and audio data may be downloaded and played automatically; thus, the problem of a non-synchronization between the sound and the picture caused by the non-standardness of the format of a video file during playing may be avoided, thereby a user experience may be improved.

### Embodiment 4

FIG. 6 shows a structural representation of an electronic device according to Embodiment 4 of the disclosure.

In this Embodiment 3, there provides an electronic device, which includes a video player 600 according to the embodiments of the disclosure, wherein a synchronous playing of the sound and the picture of a video file may be realized by executing the video playing method according to the embodiment of the disclosure.

Specifically, the electronic device may be any electronic apparatus, for example, a mobile phone, a tablet computer, an IPAD or a notebook computer, etc.

For the electronic device according to this embodiment of the disclosure, a request for downloading a video file may be sent to a server; the metadata header information of the video file is read, and the metadata header information is analyzed to acquire the start offset and the data block size of a first segment of video data as well as the start offset and the data block size of a first segment of audio data; a primary thread and a secondary thread are initiated, wherein the primary thread and the secondary thread send a request for downloading the first segment of video data and a request for downloading the first segment of audio data to the server respectively; the first segment of video data and the first segment of audio data sent by the server according to the request for downloading the first segment of video data and the request for downloading the first segment of audio data are received for being played synchronously; and the next segment of video data and audio data are downloaded and played successively, until an instruction for stop downloading the video file is received or the download of the video file is completed. By employing the electronic device of the disclosure, the problem of a non-synchronization between the sound and the picture caused by the non-standardness of the format of a video file during playing may be avoided, thereby a user experience may be improved.

The above product may perform a method according to any embodiment of the disclosure, and it may have functional modules and beneficial effects corresponding to that of the executed method. For the technical details that are not described fully in this embodiment, reference may be made to the method provided in any embodiment of the disclosure.

An embodiment of the disclosure further provides a non-transitory computer readable storage medium for storing computer executable instructions, wherein the computer executable instructions are configured to carry out any one of the above video playing methods according to the disclosure.

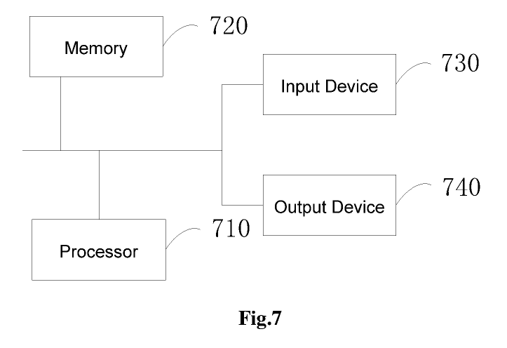

FIG. 7 shows a structural representation of an electronic equipment for carrying out the video playing method according to an embodiment of the disclosure. As illustrated in FIG. 7, the electronic equipment includes:

at least one processor 710 and a memory 720, wherein only one processor 710 is illustratively shown in FIG. 7.

The equipment executing the video playing method may also include: an input device 730 and an output device 740.

The processor 710, memory 720, input device 730 and output device 740 may be connected via a bus or other means, wherein a connecting bus is illustratively shown in FIG. 7.

The memory 720, as a non-volatile computer readable storage medium, may be used to store non-volatile software programs, non-volatile computer executable programs and modules, such as the program commands/modules corresponded to the video playing method according to the embodiments in the present disclosure. The processor 710, by running non-volatile software programs, commands and modules stored in the memory 720, performs various functional applications and data processing of the server, i.e., carries out the video displaying method according to the above embodiments in the present disclosure.

The memory 720 may include a program storage area and a data storage area, wherein the program storage area may be used to store application programs needed by an operating system or by at least one function, and the data storage area may be used to store data created by running the device for amplifying a video image, and the like. Moreover, the memory 720 may include a high speed random access memory, and also may include a non-volatile memory, such as at least one disk memory, flash memory, or other non-volatile solid state memory. According to some embodiments, the memory 720 may optionally include memories that are remotely setup with respect to the processor 710, and these remote memories may be connected to the device for amplifying a video image via a network connection. An example of such a network includes, but not limited to, internet, intranet, local area network, mobile communication network, and a combination thereof.

The input device 730 may receive input digital or character information, and generate key signal inputs concerned with user setting and functional control of the video player. The output device 740 may include displaying means such as a display screen.

The at least one module is stored in the memory 720, and, when run by the at least one processor 710, executes the video displaying method according to any one of the above method embodiments.

The above product may excite the method provided by the embodiments of the present disclosure, and has functional modules and beneficial effects corresponded to the executed method. As for technical details that are not elaborated in the present embodiments, reference can be made to the method provided by the embodiments of the present disclosure.

The electronic equipments in the embodiments of the present disclosure exist in various forms, including but not limited to:

(1) mobile communication devices, characterized in having a function of mobile communication mainly aimed at providing speech and data communication, wherein such terminal includes: smart phone (such as iPhone), multimedia phone, functional phone, low end phone and the like;

(2) ultra mobile personal computer devices, which falls in a scope of personal computer, has functions of calculation and processing, and generally has characteristics of mobile internet access, wherein such terminal includes: PDA, MID and UMPC devices, such as iPad;

(3) portable entertainment devices, which can display and play multimedia contents, anc includes audio or video player (such as iPod), portable game console, E-book and intelligent toys and portable vehicle navigation devices;

(4) server, a device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned device examples are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer apparatus (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A video playing method applied to a terminal, comprising:
S1: sending a request for downloading a video file to a server;
S2: reading metadata header information of the video file, and analyzing the metadata header information to acquire the start offset and the data block size of a first segment of video data and the start offset and the data block size of a first segment of audio data;
S3: initiating a primary thread and a secondary thread, wherein the primary thread and the secondary thread send a request for downloading the first segment of video data and a request for downloading the first segment of audio data to the server respectively;
S4: receiving the first segment of video data and the first segment of audio data sent by the server according to the request for downloading the first segment of video data and the request for downloading the first segment of audio data so as to play the first segment of video data and the first segment of audio data synchronously; and
S5: repeating the steps S2-S4, reading the metadata header information and sending a request for downloading the next segment of video data and audio data, and downloading and playing the next segment of video data and audio data successively, until an instruction for stop downloading the video file is received or the download of the video file is completed.

2. The method according to claim 1, wherein the request for downloading the first segment of video data sent by the primary thread to the server comprises the start offset and the data block size of first segment of video data, and the request for download the first segment of audio data sent by the secondary thread to the server comprises the start offset and the data block size of the first segment of audio data.

3. The method according to claim 1, wherein the video file is an MP4 file.

4. The method according to claim 1, wherein the step S1 specifically comprises:
receiving a network address of the video file to be downloaded that is input by a user via a search page, and sending a download request to the server; or
receiving a keyword that is input by a user via a search page to acquire at least one network address for the user to select, and sending a download request to the server after receiving the user selection.

5. A non-transitory computer storage medium for storing computer executable instructions that are configured for:
S1: sending a request for downloading a video file to a server;
S2: reading metadata header information of the video file, and analyzing the metadata header information to acquire the start offset and the data block size of a first segment of video data and the start offset and the data block size of a first segment of audio data;
S3: initiating a primary thread and a secondary thread, wherein the primary thread and the secondary thread send a request for downloading the first segment of video data and a request for downloading the first segment of audio data to the server respectively;
S4: receiving the first segment of video data and the first segment of audio data sent by the server according to the request for downloading the first segment of video data and the request for downloading the first segment of audio data so as to play the first segment of video data and the first segment of audio data synchronously; and
S5: repeating the steps S2-S4, reading the metadata header information and sending a request for downloading the next segment of video data and audio data, and downloading and playing the next segment of video data and audio data successively, until an instruction for stop downloading the video file is received or the download of the video file is completed.

6. The non-transitory computer storage medium according to claim 5, wherein the request for downloading the first segment of video data sent by the primary thread to the server comprises the start offset and the data block size of first segment of video data, and the request for download the first segment of audio data sent by the secondary thread to the server comprises the start offset and the data block size of the first segment of audio data.

7. The non-transitory computer storage medium according to claim 5, wherein the video file is an MP4 file.

8. The non-transitory computer storage medium according to claim 5, wherein the step S1 specifically comprises:
receiving a network address of the video file to be downloaded that is input by a user via a search page, and sending a download request to the server; or
receiving a keyword that is input by a user via a search page to acquire at least one network address for the user to select, and sending a download request to the server after receiving the user selection.

9. An electronic equipment, comprising:
at least one processor; and
and a memory communicably connected with the at least one processor;
wherein instructions executable by the at least one processor are stored in the memory, and the instructions, when being executed by the at least one processor, cause the at least one processor to:
S1: send a request for downloading a video file to a server;
S2: read metadata header information of the video file, and analyze the metadata header information to acquire the start offset and the data block size of a first segment of video data and the start offset and the data block size of a first segment of audio data;
S3: initiate a primary thread and a secondary thread, wherein the primary thread and the secondary thread send a request for downloading the first segment of video data and a request for downloading the first segment of audio data to the server respectively;
S4: receive the first segment of video data and the first segment of audio data sent by the server according to the request for downloading the first segment of video data and the request for downloading the first segment of audio data so as to play the first segment of video data and the first segment of audio data synchronously; and
S5: repeat the steps S2-S4, read the metadata header information and send a request for downloading the next segment of video data and audio data, and download and play the next segment of video data and audio data successively, until an instruction for stop downloading the video file is received or the download of the video file is completed.

10. The electronic equipment according to claim 9, wherein the request for downloading the first segment of video data sent by the primary thread to the server comprises the start offset and the data block size of first segment of video data, and the request for download the first segment of audio data sent by the secondary thread to the server comprises the start offset and the data block size of the first segment of audio data.

11. The electronic equipment according to claim 9, wherein the video file is an MP4 file.

12. The electronic equipment according to claim 9, wherein the step S1 specifically comprises to:
receive a network address of the video file to be downloaded that is input by a user via a search page, and send a download request to the server; or
receive a keyword that is input by a user via a search page to acquire at least one network address for the user to select, and send a download request to the server after receiving the user selection.
